(19) United States
(12) Patent Application Publication
(10) Pub. No.: US 2025/0231298 A1
(43) Pub. Date: Jul. 17, 2025

(54) LASER MEASUREMENT METHOD, LIDAR SYSTEM AND AUTONOMOUS VEHICLE

(71) Applicant: BEIJING MORELITE SEMICONDUCTOR CO., LTD., Beijing (CN)

(72) Inventors: Dongquan ZHANG, Beijing (CN); Xunbao RUI, Beijing (CN); Tianbo SUN, Beijing (CN)

(21) Appl. No.: 19/011,418

(22) Filed: Jan. 6, 2025

(30) Foreign Application Priority Data
Jan. 12, 2024 (CN) 202410053077.9

(51) Int. Cl. G01S 17/36; G01S 7/481; G01S 7/4912; G01S 7/4915; G01S 17/34; G01S 17/58; G01S 17/931

(52) U.S. Cl. CPC G01S 17/36; G01S 7/4817; G01S 7/4915; G01S 7/4917; G01S 17/34; G01S 17/58; G01S 17/931

(57) ABSTRACT

A LiDAR method and system and an autonomous vehicle are provided. The method includes: generating a frequency-sweeping beam which is split into a signal beam and a local-oscillation light beam; transmitting the signal beam; receiving a reflected light beam; performing time delay or frequency-shift on at least one of the signal beam, the reflected light beam or the local-oscillation light beam, and/or performing in-phase quadrature coherent demodulation on the local-oscillation light beam and the reflected light beam, so as to obtain scalar values of beat frequencies between the local-oscillation light beam and the reflected light beam; determining a speed of an object and/or a distance between the object and the LiDAR system.

### CROSS-REFERENCE TO RELATED APPLICATION

This application claims a priority to Chinese Patent Application No. 202410053077.9 filed on Jan. 12, 2024, the disclosures of which are incorporated in their entirety by reference herein.

### TECHNICAL FIELD

The present application relates to the field of Light Detection And Ranging (LiDAR) technology, and in particular, to a lase measurement method applied to a LIDAR system, a LiDAR system, and a vehicle including the LiDAR system.

### BACKGROUND

A LiDAR device can accurately measure the position (distance and angle), the motion state (speed, vibration and posture) and shape of a target object, detect, identify, distinguish and track the target object. The LiDAR device can be divided into a pulsed LiDAR device and a frequency-modulated continuous wave (FMCW) LiDAR device according to a working mode. A typical FMCW LiDAR device emits a laser beam and uses a detector to receive a reflected light beam of the target object from the nearby environment, thereby calculating the distance and speed of the target object. Due to the Doppler frequency shift effect and the performance of the LiDAR system, in order to accurately obtain a speed signal and a distance signal of the target object at a certain moment, it is necessary to have both an up-scan frequency information (i.e., information of a frequency-increasing stage) and a down-scan frequency information (i.e., information of a frequency-decreasing stage). When the frequency shift caused by the Doppler effect is greater than the frequency offset caused by the flight time of the reflected light beam, it will cause errors in the calculation of a nearby distance, resulting in a measurement blind area. In addition, the related FMCW LiDAR device can only obtain one up-scan frequency information and one down-scan frequency information in each sweeping cycle. When Doppler broadening makes it impossible to distinguish between an up-scan frequency signal and the down-scan frequency signal, one or both of the two signals will be detected incorrectly, resulting in a low detection probability.

### SUMMARY

In view of this, the present application provides a laser measurement method applied to a LiDAR system, a LiDAR system and a vehicle including the LiDAR system, so as to solve the problem of measurement blind areas caused by the Doppler effect leading to errors in calculation of a nearby distance, and to solve the problem of low detection probability caused by Doppler broadening.

In a first aspect, the present application provides a laser measurement method applied to a Light Detection and Ranging (LiDAR) system, wherein the method comprises: generating a first laser beam and a second laser beam, wherein the first laser beam and the second laser beam are frequency-modulated laser beams having a same frequency-sweeping cycle and different wavelengths, and frequencies of the first laser beam and the second laser beam change in opposite directions within each frequency-sweeping cycle; multiplexing the first laser beam and the second laser beam into a frequency-sweeping beam; splitting the frequency-sweeping beam into a signal beam and a local oscillation light beam; emitting the signal beam; receiving a reflected light beam generated when the signal beam is reflected by an object; performing in-phase orthogonal coherent demodulation on the local oscillation light beam and the reflected light beam to obtain a scalar value of a beat frequency in a frequency-increasing stage and a scalar value of a beat frequency in a frequency-decreasing stage between the local oscillation light beam and the reflected light beam; and detecting a phase and the beat frequency of the frequency-increasing stage between the local oscillation light beam and the reflected light beam, and a phase and the beat frequency of the frequency-decreasing stage between the local oscillation light beam and the reflected light beam, to determine a speed of the object and/or a distance between the object and the LiDAR system.

Optionally, the scalar value of the beat frequency in the frequency-increasing stage comprises a positive value or a negative value of the beat frequency in the frequency-increasing stage; the scalar value of the beat frequency in the frequency-decreasing stage comprises a positive value or a negative value of the beat frequency in the frequency-decreasing stage.

Optionally, before performing in-phase orthogonal coherent demodulation on the local oscillation light beam and the reflected light beam, the method further comprises: performing time-delay or frequency-shift on at least one of the signal beam, the reflected light beam or the local oscillation light beam.

Optionally, performing time-delay on at least one of the signal beam, the reflected light beam or the local oscillation light beam comprises: performing time-delay on the signal beam and the reflected light beam, or performing time-delay on the local oscillation light beam, so that the scalar value of the beat frequency in the frequency-increasing stage and the beat frequency in the frequency-decreasing stage between the local oscillation light beam and the reflected light beam increases or decreases.

Optionally, performing frequency-shift on at least one of the signal beam, the reflected light beam or the local oscillation light beam comprises: performing frequency-shift on a frequency of the signal beam or the local oscillation light beam, so that the scalar values of the beat frequency in the frequency-increasing stage and the beat frequency in the frequency-decreasing stage between the local oscillation light beam and the reflected light beam increases or decreases.

Optionally, performing in-phase orthogonal coherent demodulation on the local oscillation light beam and the reflected light beam comprises: inputting the reflected light beam and the local oscillation light beam into a 90-degree frequency-mixer to perform the in-phase orthogonal coherent demodulation.

Optionally, the beat frequency of the frequency-increasing stage and the beat frequency of the frequency-decreasing stage are located on both sides of a zero point position, when there is no Doppler frequency shift on a ranging spectrum of the LiDAR system, of the ranging spectrum.

Optionally, that the frequencies of the first laser beam and the second laser beam change in opposite directions within the frequency-sweeping cycle comprises one of following two situations: in a first half cycle of the frequency-sweeping cycle, the first laser beam sweeps from zero frequency, and the second laser beam sweeps from a maximum frequency; in a second half cycle of the frequency-sweeping cycle, the first laser beam sweeps from the maximum frequency, and the second laser beam sweeps from zero frequency; or in each of a first half cycle and a second half cycle of the frequency-sweeping cycle, the first laser beam sweeps from zero frequency, and the second laser beam sweeps from a maximum frequency.

In a second aspect, a Light Detection and Ranging (LiDAR) system is provided. The system includes a first laser source configured to generate a first laser beam; a second laser source configured to generate a second laser beam, wherein the first laser beam and the second laser beam are frequency-modulated laser having a same frequency-sweeping cycle and different wavelengths, and frequencies of the first laser beam and the second laser beam change in opposite directions within the frequency-sweeping cycle; a wavelength division multiplexer configured to multiplex the first laser beam and the second laser beam into a frequency-sweeping beam; a beam splitter configured to split the frequency-sweeping beam into a signal beam and a local oscillation light beam; an optical transceiver configured to transmit the signal beam and receive a reflected light beam generated when the signal beam is reflected by an object; an in-phase orthogonal coherent demodulator configured to perform in-phase orthogonal coherent demodulation on the local oscillation light beam and the reflected light beam, so as to obtain a scalar value of a beat frequency in a frequency-increasing stage and a scalar value of a beat frequency in a frequency-decreasing stage between the local oscillation light beam and the reflected light beam; and a detector configured to detect the beat frequency of the frequency-increasing stage and the beat frequency of the frequency-decreasing stage between the local oscillation light beam and the reflected light beam to determine a speed of the object and/or the distance between the object and the LiDAR system.

Optionally, the scalar value of the beat frequency in the frequency-increasing stage comprises a positive value or a negative value of the beat frequency in the frequency-increasing stage; the scalar value of the beat frequency in the frequency-decreasing stage includes a positive value or a negative value of the beat frequency in the frequency-decreasing stage.

Optionally, the LiDAR system further comprises: a time-delay device configured to perform time-delay on at least one of the signal beam, the reflected light beam and the local oscillation light beam before performing in-phase orthogonal coherent demodulation on the local oscillation light beam and the reflected light beam; and/or a frequency shifter configured to perform frequency-shift on at least one of the signal beam, the reflected light beam and the local oscillation light beam before performing in-phase orthogonal coherent demodulation on the local oscillation light beam and the reflected light beam.

Optionally, the time-delay device is specifically configured to perform time-delay on the signal beam and the reflected light beam, or perform time-delay on the local oscillation light beam, so that the scalar value of the beat frequency in the frequency-increasing stage and the scalar value of the beat frequency in the frequency-decreasing stage between the local oscillation light beam and the reflected light beam increase or decrease; the frequency shifter is specifically configured to perform frequency-shift on the signal beam or the local oscillation light beam so that the scalar value of the beat frequency in the frequency-increasing stage and the scalar value of the beat frequency in the frequency-decreasing stage between the local oscillation light beam and the reflected light beam increase or decrease.

Optionally, the in-phase orthogonal coherent demodulator is specifically configured to receive the reflected light beam and the local oscillation light beam to obtain the scalar value of the beat frequency in the frequency-increasing stage and the scalar value of the beat frequency in the frequency-decreasing stage between the local oscillation light beam and the reflected light beam.

Optionally, the beat frequency of the frequency-increasing stage and the beat frequency of the frequency-decreasing stage are located on both sides of a zero point position, when there is no Doppler frequency shift on a ranging spectrum of the LiDAR system, of the ranging spectrum.

Optionally, that the frequencies of the first laser beam and the second laser beam change in opposite directions within the frequency-sweeping cycle comprises one of following two situations: in a first half cycle of the frequency-sweeping cycle, the first laser beam sweeps from zero frequency, and the second laser beam sweeps from a maximum frequency; in a second half cycle of the frequency-sweeping cycle, the first laser beam sweeps from the maximum frequency, and the second laser beam sweeps from zero frequency; or in each of a first half cycle and a second half cycle of the frequency-sweeping cycle, the first laser beam sweeps from a zero frequency, and the second laser beam sweeps from a maximum frequency.

In a third aspect, an autonomous vehicle is provided. The vehicle includes the LiDAR system according to the second aspect.

The solutions of the present application can obtain the scalar values of the beat frequencies of the frequency-increasing stage and the frequency-decreasing stage of the local oscillation signal and the reflected signal, can expand the measurement spectrum range of the LiDAR system, avoid the measurement blind area caused by Doppler frequency shift, and improve the measurement accuracy. In addition, the solution of the present application uses a dual-wavelength combined laser beam as a detection light signal, which can simultaneously obtain the beat frequency of the frequency-increasing stage and the beat frequency of the frequency-decreasing stage at a sampling moment, can accurately obtain the speed and the distance of the target object, improve the angle-scanning accuracy of the LiDAR system, solve the problem of being unable to distinguish the beat frequency of the frequency-increasing stage and the beat frequency of the frequency-decreasing stage due to Doppler frequency-shift broadening, can obtain the direction of the target object, improve the signal-to-noise ratio of the signal, and solve the problem of dragging of the point cloud.

### BRIEF DESCRIPTION OF THE DRAWINGS

FIG. 1 shows a schematic diagram of the working principle of a related frequency-modulated continuous wave (FMCW) LiDAR system;

FIG. 2 shows measuring a target object in a related art to obtain a beat frequency in a frequency-increasing stage and a beat frequency in a frequency-decreasing stage;

FIGS. 3A and 3B are schematic diagrams showing that the beat frequency in the frequency-increasing stage and the beat frequency in the frequency-decreasing stage are located outside the available measurement frequency spectrum of the LiDAR system due to the Doppler frequency shift;

FIG. 4 is a schematic diagram showing a scalar value of a beat frequency in a frequency-increasing stage and a beat frequency in a frequency-decreasing stage using an in-phase IQ coherent demodulation method of the present application;

FIG. 5 shows a schematic flowchart of a LiDAR method of the present application;

FIG. 6A shows a first waveform diagram of the local oscillation light beam and the signal beam of the present application;

FIG. 6B is a schematic diagram showing a method of obtaining the beat frequencies at the frequency-increasing stage and the frequency-decreasing stage by using the waveforms of FIG. 6A;

FIG. 7A shows a second waveform diagram of the local oscillation light beam and the signal beam of the present application;

FIG. 7B is a schematic diagram showing a method of obtaining the beat frequencies of the frequency-increasing stage and the frequency-decreasing stage using the waveforms of FIG. 7A;

FIGS. 8A and 8B are schematic diagrams showing time delay of a signal beam and a reflected light beam using the LiDAR method of the present application;

FIGS. 9A and 9B are schematic diagrams in the time-frequency domain showing the time delay of the local oscillation light beam by using the LiDAR method of the present application;

FIG. 10 is a schematic diagram showing the frequency shifting of a local oscillation light beam using the LiDAR method of the present application;

FIG. 11 is a schematic diagram showing the frequency shifting of a signal beam using the LiDAR method of the present application;

FIG. 12 is a schematic diagram showing that a measurement spectrum of the LiDAR system is expanded by using the LiDAR method of the present application;

FIG. 13 shows a first schematic diagram of the structure of the LiDAR system of the present application;

FIG. 14A shows a second structural schematic diagram of the LiDAR system of the present application;

FIG. 14B shows a third structural diagram of the LiDAR system of the present application;

FIG. 15A and FIG. 15B show schematic diagrams of an autonomous vehicle including the LiDAR system of the present application.

### DETAILED DESCRIPTION

Below, the specific embodiments of the present application will be described in detail in conjunction with the accompanying drawings. When the following description refers to the drawings, unless otherwise indicated, the same numbers in different drawings represent the same or similar elements. In the following exemplary embodiments, the described embodiments are not all embodiments of the present application. On the contrary, they are only examples of devices and methods consistent with some aspects of the present application as detailed in the attached claims. In the absence of conflict, the embodiments in the present application and the features in the embodiments can be combined with each other.

FIG. 1 is a schematic diagram of the working principle of a related frequency-modulated continuous wave (FMCW) LiDAR system. The related FMCW LiDAR system 1 adopts the working principle of coherent reception. By comparing the instantaneous frequency relationship between the reflected light beam reflected from the target object 2 and the local oscillation light beam of the LiDAR system 1, information such as the distance between the target object 2 and the LiDAR system 1 and the speed of the target object can be given at the same time. The related frequency-modulated continuous wave LiDAR system can use waveforms of a periodic triangular wave or sawtooth wave as a signal beam.

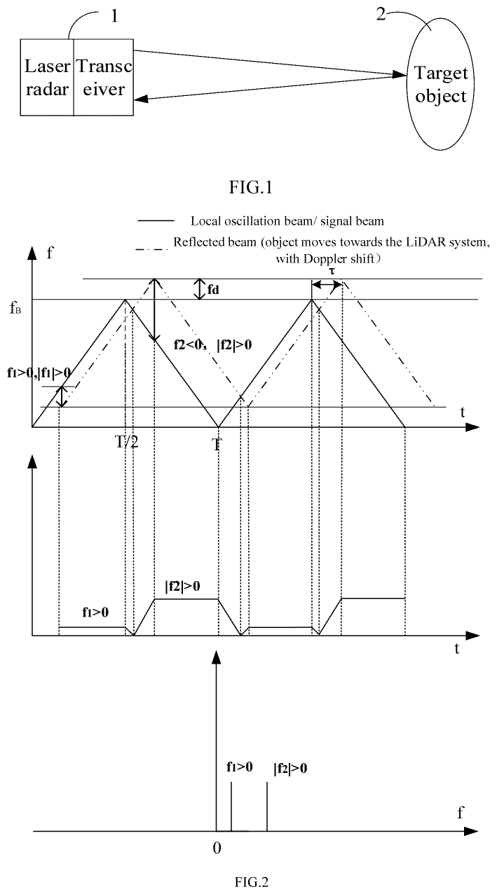

Referring to FIG. 2, which shows a schematic diagram of measuring the target object in the related art to obtain the beat frequency of the frequency-increasing stage and the beat frequency of the frequency-decreasing stage. In FIG. 2, the solid triangle wave is the instantaneous time-frequency relationship of the signal beam or the local oscillation light beam of the LiDAR system, and the dotted triangle wave is the instantaneous time-frequency relationship of the reflected light beam of the target object, where t is the delay of the reflected light beam of the target object (i.e., the flight time of the reflected light beam relative to the signal beam), f₁ and f₂ are the beat frequencies of the reflected light beam of the target object in the frequency-increasing stage and the frequency-decreasing stage between the reflected light beam and the local oscillation light beam, T is a cycle including one frequency-increasing stage and one frequency-decreasing stage, f is the frequency-sweeping bandwidth of the linear frequency modulation, and f_{d}=(f₂−f₁)/2. In FIG. 2, the beat frequencies of the frequency-increasing stage and the frequency-decreasing stage of the reflected light beam are:

$${f}_{1} = \frac{2 {f}_{B}}{T} \frac{2 R}{c} - \frac{2 v}{λ} \qquad Equation 1$$

$${f}_{2} = \frac{2 {f}_{B}}{T} \frac{2 R}{c} + \frac{2 v}{λ}$$

Assuming that the distance between the target object and the LiDAR system is R, then R=τ*c/2, where c is the speed of light and λ is the wavelength of the laser beams. In the time-frequency relationship diagram of FIG. 2, the distance R and the speed v of the target object are as follows:

$$\{ \begin{matrix}R = \frac{( {f}_{1} + {f}_{2} ) \cdot T \cdot c}{8 {f}_{B}} \\ v = \frac{( {f}_{2} - {f}_{1} ) \cdot λ}{4}\end{matrix} \qquad Equation 2$$

When f₁=0, the relationship between distance and speed can be expressed as follows:

$${R}_{m} = \frac{v \times T \times c}{2 \times λ \times {f}_{B}} \qquad Equation 3$$

In the above Equation 2, the absolute values of f₁ and f₂ are required, that is, both f₁ and f₂ are required to be greater than 0, and the actual distance between the LiDAR system and the target object needs to be greater than the value Rm of R calculated by the above Equations, that is, it is necessary to ensure that the value of R R>Rm, that is

$$R > \frac{v \times T \times c}{2 \times λ \times {f}_{B}} ,$$

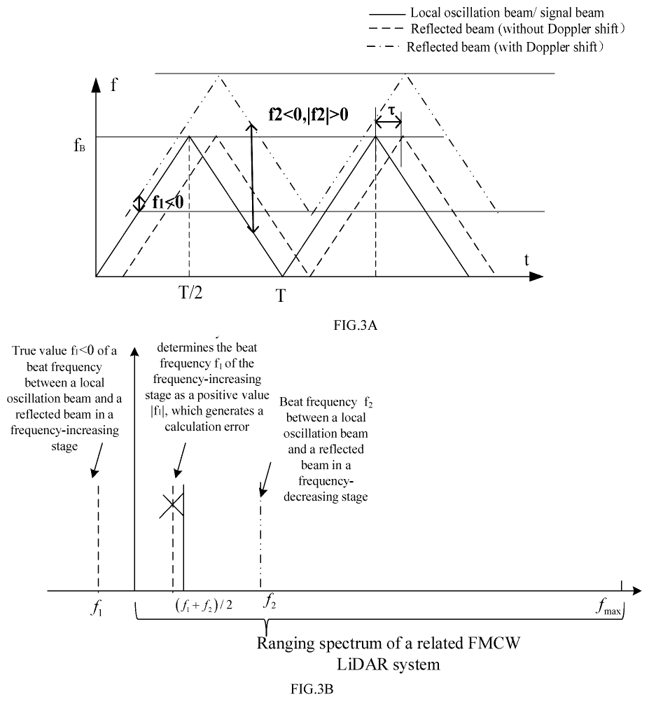

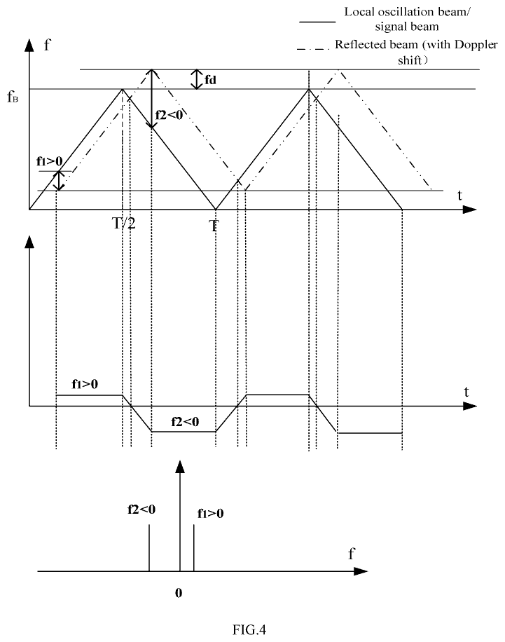

a value of R being less than the above value Rm will lead to errors in the calculation of speed and distance. In addition, it can be seen from Equation 3 that R is proportional to the speed v of the target object. The larger the speed v of the target object, the larger the above R value. When the actual speed v of the target object is faster, the frequency shift caused by the Doppler effect may be greater than the frequency shift caused by the flight time of the reflected light beam, resulting in the actual value of the beat frequency f₁ in the frequency-increasing stage between the local oscillation light beam and the received reflected light beam being a negative value, as shown in FIG. 3. Although the beat frequency f₁ in the frequency-increasing stage between the local oscillation light beam and the received reflected light beam is actually a negative value (less than 0), the LiDAR system judges the frequency f₁ as a positive value (greater than 0), so when the above Equations 1-3 are used to calculate the distance and the speed of the target object, the calculated distance and the calculated speed will be wrong, resulting in a measurement blind area.

The present application adopts the in-phase quadrature (IQ) coherent demodulation method to obtain the real values of the beat frequencies in the frequency-increasing stage and the frequency-decreasing stage between the reflected light beam and the local oscillation light beam, that is, the scalar values (positive or negative value, that is, a value greater than 0 or less than 0), as shown in FIG. 4. The technical solutions of the present application can obtain the real values, rather than the absolute values of the beat frequencies in the frequency-increasing stage and in the frequency-decreasing stage (only values greater than 0), which can effectively avoid the ranging blind area. Since information of the negative frequency is obtained, the solution of the present application can also increase the width of the ranging spectrum of the LiDAR system.

Specifically, when the in-phase IQ coherent demodulation method of the present application is used to obtain the scalar values of the beat frequency in the frequency-increasing stage and the beat frequency in the frequency-decreasing stage, the used calculation method is also different from the above Equations 1-2. When the target object moves toward the LiDAR system, the frequency of the reflected light beam increases relative to the frequency of the local oscillation light beam. At this time, the beat frequency in the frequency-increasing stage and the beat frequency in the frequency-decreasing stage of the reflected light beam are respectively:

$${f}_{1} = \frac{2 {f}_{B}}{T} \frac{2 R}{c} - \frac{2 v}{λ} \qquad Equation 4$$

$${f}_{2} = - \frac{2 {f}_{B}}{T} \frac{2 R}{c} - \frac{2 v}{λ}$$

The distance and speed of the target object are as follows:

$$\{ \begin{matrix}R = \frac{( {f}_{1} - {f}_{2} ) \cdot T \cdot c}{8 {f}_{B}} \\ v = - \frac{( {f}_{2} + {f}_{1} ) \cdot λ}{4}\end{matrix} \qquad Equation 5$$

When the target object moves away from the LiDAR system, the frequency of the reflected light beam decreases relative to the frequency of the local oscillation light beam. At this time, the beat frequencies of the reflected light beam in the frequency-increasing stage and the frequency-decreasing stage are:

$${f}_{1} = \frac{2 {f}_{B}}{T} \frac{2 R}{c} + \frac{2 v}{λ} \qquad Equation 6$$

$${f}_{2} = - \frac{2 {f}_{B}}{T} \frac{2 R}{c} + \frac{2 v}{λ}$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} ) \cdot λ}{4}\end{matrix} \qquad Equation 7$$

By adopting the above Equations 4-7, the scalar values (true values) of the beat frequencies in the frequency-increasing stage and the frequency-decreasing stage can be accurately obtained, which can expand the measurement spectrum of the LiDAR system and avoid the ranging blind area caused by Doppler frequency shift.

The present application also adopts a dual-wavelength modulation method. In addition to obtaining the real frequency information of the beat frequency in the frequency-increasing stage and the beat frequency in the frequency-decreasing stage, the beat frequency in the frequency-increasing stage and the beat frequency in the frequency-decreasing stage can also be obtained at the same detection moment (in the same fast Fourier transform FFT time window), which can improve the success rate of detection, improve the angle scanning accuracy of the LiDAR system, solve the problem that the beat frequency in the frequency-increasing stage and the beat frequency in the frequency-decreasing stage cannot be distinguished due to Doppler broadening, and can obtain the speed direction of the target object and improve the signal-to-noise ratio (SNR) of the detected signal. The specific embodiments of the present application are described below.

In some embodiments, the present disclosure provides a laser measurement method, i.e., a Light Detection And Ranging (LiDAR) method. The laser measurement method can be applied to a frequency-modulated continuous wave (FMCW) LiDAR system. As shown in FIG. 5, the laser measurement method includes the following steps S501-S506.

Step S501: generating a first laser beam and a second laser beam.

Specifically, the first laser beam and the second laser beam may be generated by a first laser source and a second laser source, respectively. The first laser source and the second laser source may be directly modulated by a chirp signal for an optical signal. For example, a driving signal (i.e., the chirp signal) for controlling the laser sources may be input to the laser source with an intensity that varies with time, so that the laser source generates and outputs a laser beam, i.e., a light beam whose frequency varies within a predetermined range.

In some embodiments, each of the first laser source and the second laser source may further include a modulator that receives a modulation signal. The modulator may be configured to modulate the light beam based on the modulation signal to generate and output a laser beam, the frequency of which varies within a predetermined range. The principle of generating the laser beam by a FMCW LiDAR system is well known to those skilled in the art. In order to save space, this article will not further describe the principle herein.

The first laser beam and the second laser beam are frequency-modulated continuous wave laser beams having the same frequency-sweeping cycle T and different wavelengths λ₁ and λ₂.

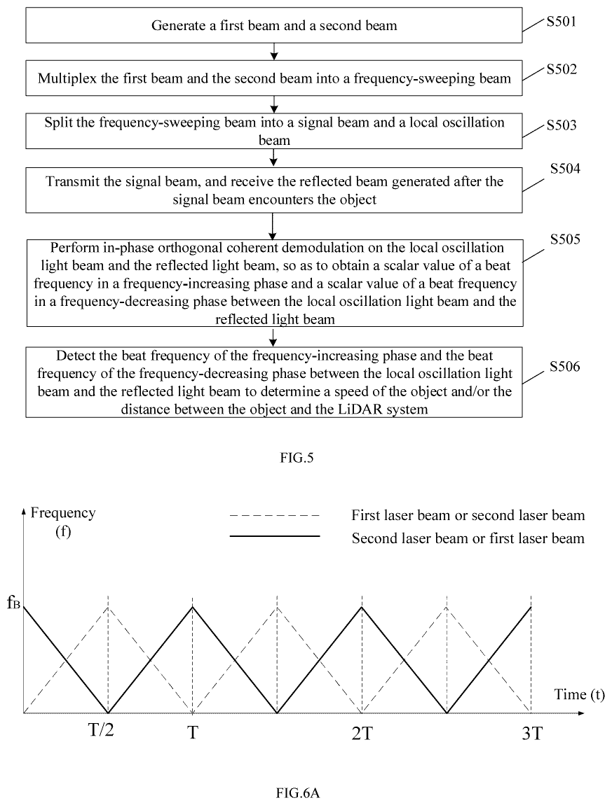

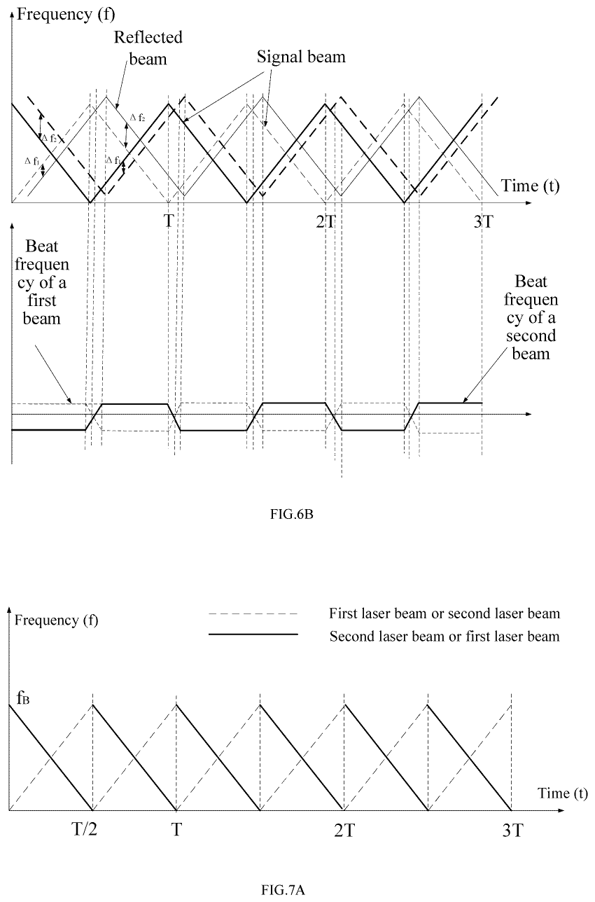

Optionally, in each frequency-sweeping cycle T, the first laser beam and the second laser beam may both be triangular-wave frequency-sweeping waveforms, that is, detection signals whose frequency-sweeping waveforms are triangle, or detection signals whose time-frequency waveforms are triangular waveforms. The modulation depth of the first laser beam is the same as the modulation depth of the second laser beam, and the modulation depth refers to the ratio between the maximum value and the minimum value of the laser during modulation, usually expressed in decibels (dB). The modulation slope of the first laser beam is the same as the modulation slope of the second laser beam, for example, both are 2f_{B}/T. The frequency change directions of the first laser beam and the second laser beam are opposite within the frequency-sweeping cycle T. Specifically, as shown in FIG. 6A, the start time of the first laser beam and the start time of the second laser beam may differ by half a cycle, the first laser beam may start scanning from zero frequency, and the second laser beam may start scanning from the maximum frequency f_{B}. In FIG. 6A, the moment when the first laser beam is at zero frequency is also the moment when the second laser beam is at the maximum frequency f_{B}.

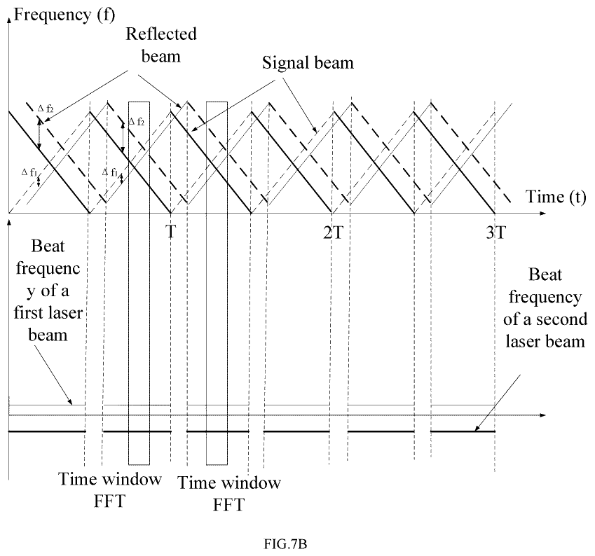

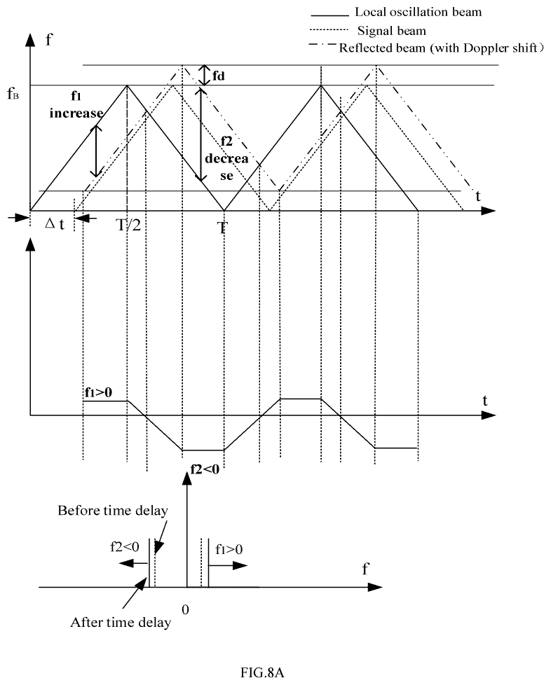

Optionally, as shown in FIG. 7A, in each frequency-sweeping cycle T, the first laser beam and the second laser beam may both be periodic frequency-sweeping waveforms. The modulation depth of the first laser beam is the same as the modulation depth of the second laser beam; the modulation slope of the first laser beam is the same as the modulation slope of the second laser beam, for example, both are 2f B/T. Different from FIG. 6A, in FIG. 7A, each of the first laser beam and the second laser beam is a sawtooth waveform, and in the first half cycle and the second half cycle of the frequency-sweeping cycle T, the frequency change directions of the first laser beam and the second laser beam are opposite, the first laser beam may linearly increase from zero frequency to the maximum frequency f_{B}, and the second laser beam may linearly decrease from the maximum frequency f_{B} to zero frequency; or the second laser beam may linearly increase from zero frequency to the maximum frequency f_{B}, and the first laser beam may linearly decrease from the maximum frequency f_{B} to zero frequency.

Step S502: multiplexing the first laser beam and the second laser beam into a frequency-sweeping beam.

Specifically, a wavelength division multiplexer can be used to multiplex the first laser beam and the second laser beam into a frequency-sweeping beam. The frequency-sweeping beam carries two optical signals of two different wavelengths λ₁, λ₂. The wavelength division multiplexer can be common to those skilled in the art, for example, a dense optical wavelength division multiplexer or an optical division multiplexer, etc.

Step S503: splitting the frequency-sweeping beam into a signal beam and a local oscillation light beam.

In some examples, a beam splitter (also called an optical splitter) can be used to split the frequency-sweeping beam into a signal beam and a local oscillation light beam. The signal beam and the local oscillation light beam have the same frequency, the same modulation depth, the same waveform, and the same slope at any point in time. Each of the signal beam and the local oscillation light beam carries two optical signals of two different wavelengths λ₁ and λ₂ at the same time. In some examples, the beam splitter can specifically be a specific-wavelength coupler (splitter) for wavelengths of 445˜2100 nm, such as a 1×2 beam splitter based on an optical chip and an SMC series beam splitter. In other examples, other beam splitters known to those skilled in the art that can split the frequency-sweeping beam into a signal beam and a local oscillation light beam can also be used.

Step S504: emitting the signal beam, and receiving a reflected light beam generated when the signal beam is reflected by an object.

In some examples, an optical transmitter and receiver or an optical transceiver is used to emit the signal beam at a predetermined angle, and a light receiver or the optical transceiver is used to receive reflected light reflected by the target object.

Specifically, a polarization beam splitter (e.g., polarization splitter-rotator (PSR)), a circulator (e.g., a three-port circulator), a lens assembly, a beam scanning guide, etc. may be included between the optical transceiver and the target object. The lens assembly is configured to collimate the signal beam and focus the reflected light beam to couple into the optical transceiver. The beam scanning guide is configured to achieve light deflection and scanning.

Step S505: performing in-phase orthogonal coherent demodulation on the local oscillation light beam and the reflected light beam, so as to obtain scalar values of the beat frequency in the frequency-increasing stage and the beat frequency in the frequency-decreasing stage between the local oscillation light beam and the reflected light beam.

In an embodiment of the present application, the in-phase IQ (In-phase and Quadrature) coherent demodulation method is used to measure the moving target object, and the beat frequency f₁ (i.e., frequency difference) in the frequency-increasing stage between an rising edge of the local oscillation light beam and an rising edge of the reflected light beam and the beat frequency f₂ (i.e., frequency difference) in the frequency-decreasing stage between a falling edge of the local oscillation light beam and the falling edge of the reflected light beam can be obtained. The scalar values (i.e., value with positive and negative signs) can be obtained, so that the frequency range of the negative frequency band can be fully utilized, and the measurement spectrum of the LiDAR system can be expanded. The measurement spectrum of the LiDAR system refers to the frequency range of the beat frequency f₁ in the frequency-increasing stage and the beat frequency f₂ in the frequency-decreasing stage that can be measured by the LiDAR system, as shown in FIG. 3B. In the relevant FMCW LiDAR system, the range of the measurement spectrum can be [0, +fₘₐₓ], fₘₐₓ is the maximum value of the beat frequency in the frequency-decreasing stage between the local oscillation light beam and the reflected light beam of the LiDAR system, so the relevant FMCW LiDAR system can only obtain the absolute values (positive values) of the beat frequency in the frequency-increasing stage and the beat frequency in the frequency-decreasing stage. Due to the influence of the Doppler effect, when the distance between the target object and the LiDAR system is close enough or the relative speed is fast enough, the true value of the beat frequency f₁ between the rising edge of the local oscillation light beam and the rising edge of the reflected light beam or the true value of the beat frequency f₁ between the falling edge of the local oscillation light beam and the falling edge of the reflected light beam may be negative. Therefore, if the measurement spectrum of the relevant LiDAR system is used, the true value of the beat frequency f₁ in the frequency-increasing stage may be located outside the range of the measurement spectrum, resulting in errors in the calculation of the speed and the distance of the target object and a measurement blind area is caused.

Specifically, a 90-degree frequency-mixing unit can be used to obtain the scalar values of the beat frequency of the frequency-increasing stage and the beat frequency of the frequency-decreasing stage of the local oscillation light beam and the reflected light beam. The 90-degree frequency-mixing unit can perform a 90-degree frequency-mixing operation on the local oscillation light beam and the reflected light beam, and input the mixed signal to a first balanced detector and a second balanced detector for detection. The 90-degree frequency-mixing unit is configured to coherently mix the local oscillation light beam and the reflected light beam so that the relative phase differences of the four output ports of the frequency-mixing unit are 0°, 90°, 180°, and 270°, respectively. The 90-degree frequency-mixing unit can be a 90-degree frequency-mixing unit known to those skilled in the art. This application will not be described in detail herein.

In some embodiments, before performing in-phase orthogonal coherent demodulation on the local oscillation light beam and the reflected light beam, the method further includes: performing time-delay or frequency-shift on at least one of the signal beam, the reflected light beam and the local oscillation light beam.

In some embodiments, performing time-delay on at least one of the signal beam, the reflected light beam, and the local oscillation light beam includes: performing time-delay on the signal beam and the reflected light beam, or performing time-delay on the local oscillation light beam, so that the beat frequency of the frequency-increasing stage and the beat frequency of the frequency-decreasing stage between the local oscillation light beam and the reflected light beam move toward the first direction or the second direction of the ranging spectrum of the LiDAR system. The first direction of the ranging spectrum is the direction in which the beat frequency of the frequency-increasing stage and the beat frequency of the frequency-decreasing stage gradually increase, such as the right direction of the frequency axis. The second direction of the ranging spectrum is the direction in which the beat frequency of the frequency-increasing stage and the beat frequency of the frequency-decreasing stage gradually decrease, such as the left direction of the frequency axis. Therefore, by performing time-delay on at least one of the signal beam, the reflected light beam, and the local oscillation light beam, the scalar values of the beat frequency of the frequency-increasing stage and the beat frequency of the frequency-decreasing stage can be increased or decreased.

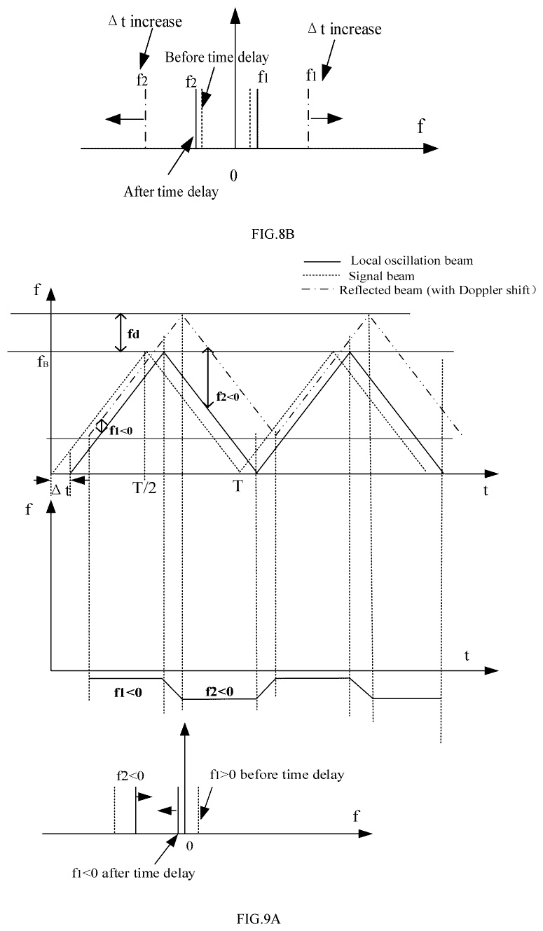

Taking the triangular wave of the first laser beam as an example, as shown in FIG. 8A, when both the signal beam and the reflected light beam are delayed by Δt, when the target object moves away from the LiDAR system, the beat frequencies of the reflected light beam and the local oscillation beam in the frequency-increasing stage and the frequency-decreasing stage are respectively:

$${f}_{1} = \frac{2 {f}_{B}}{T} ( \frac{2 R}{c} + Δ t ) + \frac{2 v}{λ} \qquad Equation 8$$

$${f}_{2} = - \frac{2 {f}_{B}}{T} ( \frac{2 R}{c} + Δ t ) + \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} - \frac{1}{2} Δ t ] \times c \\ v = \frac{( {f}_{2} + {f}_{1} ) \cdot λ}{4}\end{matrix} \qquad Equation 9$$

When the target object moves toward the LiDAR system, the frequency of the reflected light beam increases relative to the frequency of the local oscillation light beam. At this time, the beat frequencies of the reflected light beam and the local oscillation beam in the frequency-increasing stage and the frequency-decreasing stage are:

$${f}_{1} = \frac{2 {f}_{B}}{T} \cdot ( \frac{2 R}{c} + Δ t ) - \frac{2 v}{λ} \qquad Equation 10$$

$${f}_{2} = - \frac{2 {f}_{B}}{T} \cdot ( \frac{2 R}{c} + Δ t ) - \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} - \frac{1}{2} Δ t ] \times c \\ v = - \frac{( {f}_{2} + {f}_{1} ) \cdot λ}{4}\end{matrix} \qquad Equation 11$$

As shown in FIG. 8B, when Δt increases, the beat frequency f₁ in the frequency-increasing stage and the beat frequency f₂ in the frequency-decreasing stage between the local oscillation light beam and the reflected light beam move in opposite directions, thereby increasing the spacing therebetween. Vice versa, when Δt decreases, the beat frequency f₁ in the frequency-increasing stage and the beat frequency f₂ in the frequency-decreasing stage between the local oscillation light beam and the reflected light beam move in opposite directions, thereby decreasing the spacing therebetween. When Δt continues to decrease, the beat frequency f₁ in the frequency-increasing stage and the beat frequency f₂ in the frequency-decreasing stage may pass each other and move in opposite directions, resulting in increasing the spacing therebetween.

Taking the triangular wave of the first laser beam as an example, as shown in FIG. 9A, in this embodiment, the local oscillation light beam is time-delayed by a time delay of Δt. When the target object moves away from the LiDAR system, the beat frequencies of the reflected light beam and the local oscillation light beam in the frequency-increasing stage and the frequency-decreasing stage are respectively:

$${f}_{1} = \frac{2 {f}_{B}}{T} \cdot ( \frac{2 R}{c} - Δ t ) + \frac{2 v}{λ} \qquad Equation 12$$

$${f}_{2} = - \frac{2 {f}_{B}}{T} \cdot ( \frac{2 R}{c} - Δ t ) + \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} + \frac{1}{2} Δ t ] \times c \\ v = \frac{( {f}_{2} + {f}_{1} ) \cdot λ}{4}\end{matrix} \qquad Equation 13$$

When the target object moves toward the LiDAR system, the frequency of the reflected light beam increases relative to the frequency of the local oscillation light beam. At this time, the beat frequencies of the reflected light beam and the local oscillation light beam in the frequency-increasing stage and the frequency-decreasing stage are:

$$f 1 = \frac{2 {f}_{B}}{T} \cdot ( \frac{2 R}{c} - Δ t ) - \frac{2 v}{λ} \qquad Equation 14$$

$${f}_{2} = - \frac{2 {f}_{B}}{T} \cdot ( \frac{2 R}{c} - Δ t ) - \frac{2 v}{λ}$$

The distance and the speed of the target object are as follows:

$$\{ \begin{matrix}R = [ \frac{( {f}_{1} - {f}_{2} ) \cdot T \cdot }{8 {f}_{B}} + \frac{1}{2} Δ t ] \times c \\ v = - \frac{( {f}_{2} + {f}_{1} ) \cdot λ}{4}\end{matrix} \qquad Equation 15$$

As shown in FIG. 9B, when Δt increases, the beat frequency f₁ in the frequency-increasing stage and the beat frequency f₂ in the frequency-decreasing stage between the local oscillation light beam and the reflected light beam move in opposite directions, thereby reducing the spacing therebetween. When Δt continues to increase, the beat frequency f₁ in the frequency-increasing stage and the beat frequency f₂ in the frequency-decreasing stage may cross each other and move in opposite directions, resulting in an increase of the spacing therebetween. Vice versa, when Δt decreases, the beat frequency f₁ in the frequency-increasing stage and the beat frequency f₂ in the frequency-decreasing stage between the local oscillation light beam and the reflected light beam move in opposite directions, thereby increasing the spacing therebetween.

In the above embodiments, both the signal beam and the reflected light beam can be time-delayed, and/or the local oscillation light beam can be time-delayed. By time-delaying one or more of the signal beam, the reflected light beam and the local oscillation light beam, the beat frequency f₁ in the frequency-increasing stage and the beat frequency f₂ in the frequency-decreasing stage between the local oscillation light beam and the reflected light beam can be changed in the measurement spectrum of the LiDAR system, and the speed of the target object and the distance between the LiDAR system and the target object can be correctly calculated according to the above Equations, thereby avoiding the measurement blind area and improving the measurement accuracy. In addition, since time delay is used, a time-delay system provided in the embodiments of the present application can be used as a measurement scale of the LiDAR measurement system, to accurately obtain the position of the measurement zero point.

In some embodiments, a time-delay device may be used to perform time-delay on the waveforms of the signal beam and the reflected light beam. The number of time-delay devices may be one or more (e.g., multiple time-delay devices in series, such as multiple time-delay optical fibers), so that one or more of the signal beam, the reflected light beam, and the local oscillation light beam are all time-delayed. The parameters of the time-delay device may be defined based on the performance of the LiDAR system and the maximum moving speed of the target object, and will not be described in detail in this application.

In the embodiment shown in FIG. 6, the start time of the triangular wave of the second laser beam differs from the start time of the triangular wave of the first laser beam by half a cycle. The above methods for obtaining the beat frequency of the frequency-increasing stage and the beat frequency of the frequency-decreasing stage of the triangular wave waveform of the first laser beam and calculating the distance and the speed of the target object are also applicable to the beat frequency of the frequency-increasing stage and the beat frequency of the frequency-decreasing stage of the triangular wave of the second laser beam. For details, please refer to the above description, and this application will not be described in detail.

For the case where both the first laser beam and the second laser beam are sawtooth waveforms, as shown in FIG. 7A and FIG. 7B, in each frequency-sweeping cycle, the frequency-increasing stage of the first laser beam and the frequency-decreasing stage of the second laser beam form a triangular wave waveform, and the frequency-decreasing stage of the second laser beam and the frequency-increasing stage of the first laser beam form an inverted triangular wave waveform. In each frequency-sweeping cycle, the first laser beam only corresponds to the beat frequency f₁ in the frequency-increasing stage, and the second laser beam only corresponds to the beat frequency f₂ in the frequency-decreasing stage. Therefore, in each frequency-sweeping cycle, the calculation equations for the speed and the distance of the target object is similar to the above Equations 8-15, the difference therebetween is that the first laser beam only corresponds to the beat frequency f₁ in the frequency-increasing stage, and the second laser beam only corresponds to the beat frequency f₂ in the frequency-decreasing stage. For details, please refer to the above description, and this application will not be described in detail here.

In some embodiments, performing frequency-shift on at least one of the signal beam, the reflected light beam, and the local oscillation light beam includes: performing frequency-shift on the frequency of the signal beam or the local oscillation light beam so that the beat frequency of the frequency-increasing stage and the beat frequency of the frequency-decreasing stage between the local oscillation light beam and the reflected light beam are shifted toward the first direction or the second direction of the measurement spectrum.

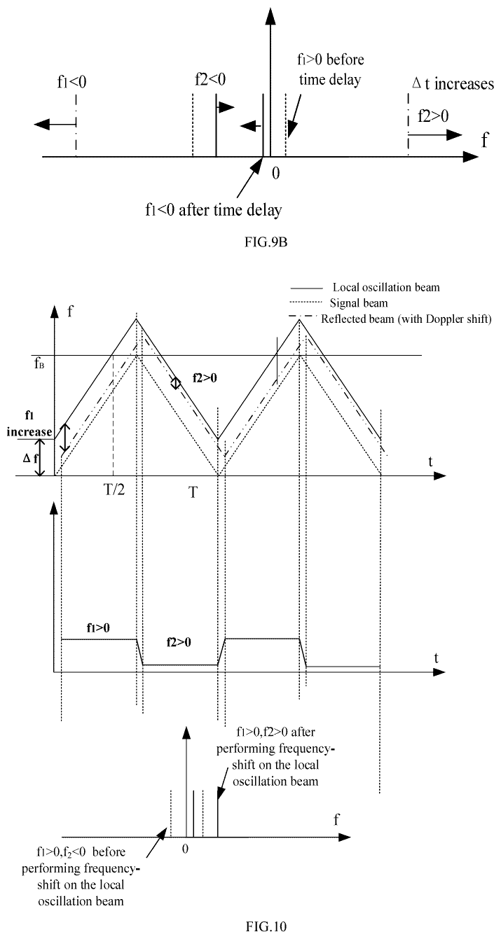

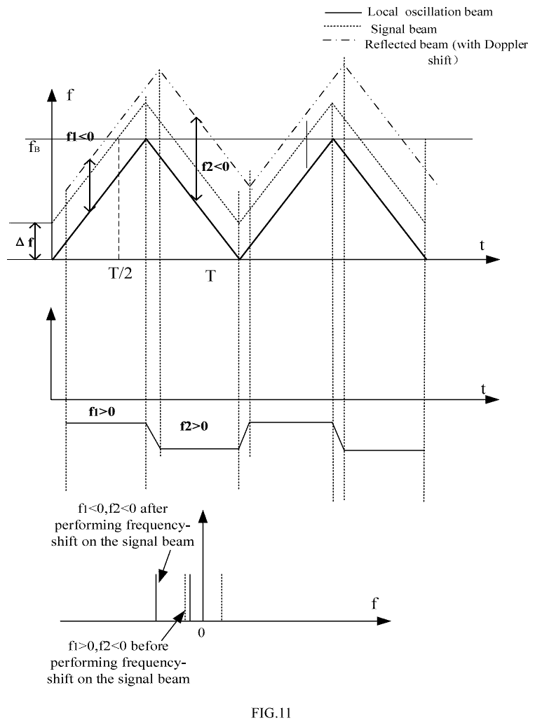

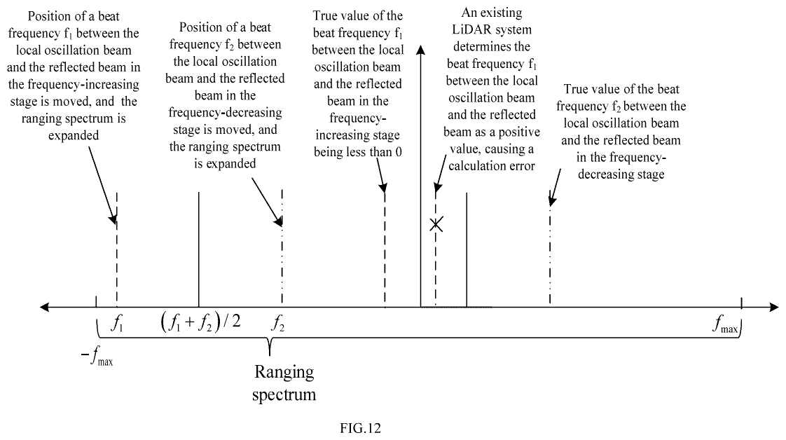

The first direction of the ranging spectrum is a direction in which the beat frequency in the frequency-increasing stage and the beat frequency in the frequency-decreasing stage gradually increase, such as the right direction of the frequency axis in FIGS. 10 and 11. The second direction of the ranging spectrum is a direction in which the beat frequency in the frequency-increasing stage and the beat frequency in the frequency-decreasing stage gradually decrease, such as the left direction of the frequency axis in FIGS. 10 and 11. Therefore, by performing frequency-shift on at least one of the signal beam, the reflected light beam, and the local oscillation light beam, the scalar values of the beat frequency in the frequency-increasing stage and the beat frequency in the frequency-decreasing stage can be increased or decreased.

In some embodiments, when the frequency of the local oscillation light beam is shifted, the frequency of the local oscillation light beam can be increased or decreased as a whole. Taking the triangular wave of the first laser beam as an example, as shown in FIG. 10, the frequency of the local oscillation light beam is increased by Δf as a whole. When the target object moves away from the LiDAR system, the beat frequency in the frequency-increasing stage and the beat frequency in the frequency-decreasing stage are respectively:

$${f}_{1} = \frac{2 {f}_{B}}{T} \cdot \frac{2 R}{c} + \frac{2 v}{λ} + Δ f \qquad Equation 16$$

$${f}_{2} = - \frac{2 {f}_{B}}{T} \cdot \frac{2 R}{c} + \frac{2 v}{λ} + Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} - 2 Δ f ) \cdot λ}{4}\end{matrix} \qquad Equation 17$$

When the target object moves toward the LiDAR system, the beat frequencies in the frequency-increasing stage and the frequency-decreasing stage are:

$${f}_{1} = \frac{2 {f}_{B}}{T} \cdot \frac{2 R}{c} - \frac{2 v}{λ} + Δ f \qquad Equation 18$$

$${f}_{2} = - \frac{2 {f}_{B}}{T} \cdot \frac{2 R}{c} - \frac{2 v}{λ} + Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} - 2 Δ f ) \cdot λ}{4}\end{matrix} \qquad Equation 19$$

In some embodiments, when the frequency of the signal beam is shifted, the frequency of the signal beam may be increased or decreased as a whole. For example, as shown in FIG. 11, the frequency of the signal beam is increased as a whole by Δf. When the target object moves away from the LiDAR system, the beat frequency in the frequency-increasing stage and the beat frequency in the frequency-decreasing stage are respectively:

$${f}_{1} = \frac{2 {f}_{B}}{T} \cdot \frac{2 R}{c} + \frac{2 v}{λ} - Δ f \qquad Equation 20$$

$${f}_{2} = - \frac{2 {f}_{B}}{T} \cdot \frac{2 R}{c} + \frac{2 v}{λ} - Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( {f}_{2} + {f}_{1} + 2 Δ f ) \cdot λ}{4}\end{matrix} \qquad Equation 21$$

When the target object moves toward the LiDAR system, the beat frequencies in the frequency-increasing stage and the frequency-decreasing stage are:

$${f}_{1} = \frac{2 {f}_{B}}{T} \cdot \frac{2 R}{c} - \frac{2 v}{λ} - Δ f \qquad Equation 22$$

$${f}_{2} = - \frac{2 {f}_{B}}{T} \cdot \frac{2 R}{c} - \frac{2 v}{λ} - Δ f$$

The distance and the speed of the target object are as follows:

$$\{ \begin{matrix}R = \frac{( {f}_{1} - {f}_{2} ) \cdot T \cdot c}{8 {f}_{B}} \\ v = \frac{( - {f}_{2} - {f}_{1} - 2 Δ f ) \cdot λ}{4}\end{matrix} \qquad Equation 23$$

In some embodiments, the minimum value of the scalar values of the beat frequency in the frequency-increasing stage and the beat frequency in the frequency-decreasing stage is equal to the maximum negative frequency shift caused by the Doppler effect.

In some embodiments of the present application, the start time of the triangular wave of the second laser beam differs from the start time of the triangular wave of the first laser beam by half a cycle. The above calculation method for the beat frequency of the frequency-increasing stage and the beat frequency of the frequency-decreasing stage of the triangular wave of the first laser beam and the distance and the speed of the target object is also applicable to the calculation of the beat frequency of the frequency-increasing stage and the beat frequency of the frequency-decreasing stage of the triangular wave of the second laser beam. For details, please refer to the above description, and this application will not be described in detail.

For the case where both the first laser beam and the second laser beam are sawtooth waveforms, as shown in FIG. 7A and FIG. 7B, in each frequency-sweeping cycle, the frequency-increasing stage of the first laser beam and the frequency-decreasing stage of the second laser beam form a triangular wave waveform, and the frequency-decreasing stage of the second laser beam and the frequency-increasing stage of the first laser beam form an inverted triangular wave waveform. Therefore, in each frequency-sweeping cycle, the first laser beam only corresponds to the beat frequency f₁ of the frequency-increasing stage, and the second laser beam only corresponds to the beat frequency f₂ of the frequency-decreasing stage. Therefore, in each frequency-sweeping cycle, the calculation equations for the speed and the distance of the target object are similar to the above equations 16-23, except that the first laser beam only corresponds to the beat frequency f₁ of the frequency-increasing stage, and the second laser beam only corresponds to the beat frequency f₂ of the frequency-decreasing stage. For details, please refer to the above description, and this application will not be described in detail here.

By shifting the frequency of the local oscillation light beam and/or the signal beam, the positions of the beat frequencies in the frequency-increasing stage and the frequency-decreasing stage on the measurement spectrum of the LiDAR system can be changed. Combined with the in-phase orthogonal coherent demodulation method of the present application, the range of the measurement spectrum of the LiDAR system can be expanded from [0, fₘₐₓ] to [−fₘₐₓ, fₘₐₓ] thereby avoiding measurement blind areas.

Step S506: detecting the beat frequency of the frequency-increasing stage and the beat frequency of the frequency-decreasing stage between the local oscillation light beam and the reflected light beam to determine the speed of the target object and/or the distance between the target object and the LiDAR system.

Specifically, a balanced detector can be used to measure the beat frequencies of the local oscillation light beam and the reflected light beam. The balanced detector can be a photoelectric detector.

In some embodiments, step S506 specifically includes: mixing the received reflected light beam with the local oscillation light beam to obtain a mixed signal. Specifically, the local oscillation light beam of the present application is a light beam signal including two different wavelengths λ₁ and λ₂, and the reflected light beam is also a light beam including two different wavelengths λ₁ and λ₂. By mixing the reflected light beam with the local oscillation light beam, a mixing result of a first reflected light of a wavelength λ₁ and a first local oscillation light and a mixing result of a second reflected light of a wavelength λ₂ and a second local oscillation light can be obtained simultaneously. Therefore, at the same moment, the beat frequency information of the frequency-increasing stage and the beat frequency information of the frequency-decreasing stage can be obtained simultaneously, which can improve the detection accuracy, solve the problem that the frequency in the frequency-increasing stage and the frequency in the frequency-decreasing caused by Doppler broadening of the Doppler effect cannot be distinguished, the direction of the target speed can be obtained, and the signal-to-noise ratio of the signals can be enhanced.

A frequency-mixer can be used to mix the local oscillation light beam with the received reflected light beam to obtain a mixed signal. The mixer can be a coupler, such as a 2×2 coupler, and the mixing signal is, for example, a coherent signal generated by the interference between the local oscillation light beam and the corresponding reflected light beam. The mixer or coupler can be a mixer and a coupler well known to those skilled in the art. In order to save space, this application will not describe them in detail.

The above-mentioned solution of the present application uses the in-phase IQ coherent demodulation method to obtain the true values of the beat frequency in the frequency-increasing stage and the beat frequency in the frequency-decreasing stage between the local oscillation light beam and the reflected light beam, and can simultaneously obtain the beat frequency signal of the frequency-increasing stage and the beat frequency signal of the frequency-decreasing stage distributed on both sides of the zero point at one detection moment (i.e., within the same time window), thereby expanding the measurement spectrum of the LiDAR system, avoiding the measurement blind area, and improving the measurement accuracy and angular resolution.

Optionally, the beat frequency of the frequency-increasing stage and the beat frequency of the frequency-decreasing stage are located on both sides of the frequency of the ranging zero point position when there is no Doppler frequency shift on the ranging spectrum of the LiDAR system, in the ranging spectrum.

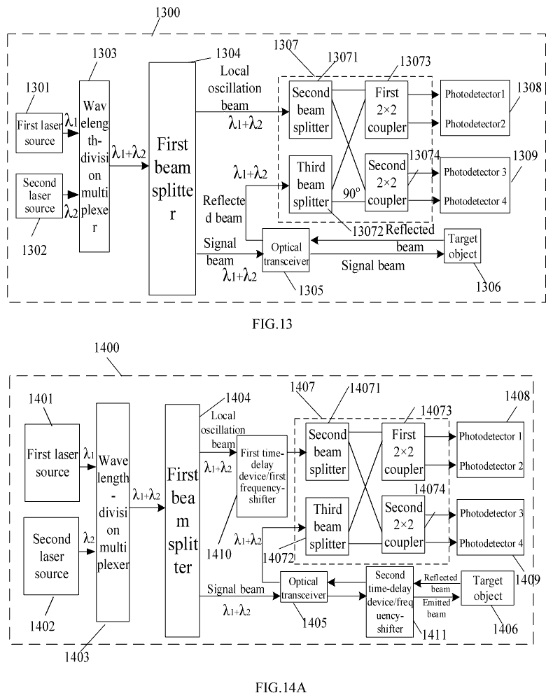

The LiDAR system provided by the present disclosure is described in detail below. FIG. 13 shows a schematic diagram of the structure of the LiDAR system of the present application. In this embodiment, the LiDAR system 1300 includes a first laser source 1301 configured to generate a first laser beam; and a second laser source 1302 configured to generate a second laser beam.

The first laser source 1301 and the second laser source 1302 can be driven directly by modulation of the chirp signal for the optical signal. For example, the chirp signal for controlling the laser source can be input to the first laser source and the second laser source with an intensity that varies with time, so that the first laser source and the second laser source generate and output the first laser beam and the second laser beam, and the first laser beam and the second laser beam are frequency-modulated continuous wave laser beams whose frequencies vary within a predetermined range, with the same sweep cycle T and different wavelengths λ₁ and λ₂. Optionally, in each sweep cycle T, the first laser beam and the second laser beam can both be triangular-wave sweeping waveforms or sawtooth-wave sweeping waveforms.

Optionally, each of the first laser source 1301 and the second laser source 1302 can include a modulator that receives a modulation signal. The modulator can be configured to modulate the beams based on the modulation signal to generate and output laser beams, and the frequencies of the laser beams vary within a predetermined range.

The modulation depth of the first laser beam and the modulation depth of the second laser beam are the same, and the modulation slope thereof are same. The frequency change directions of the first laser beam and the second laser beam are opposite in the frequency-sweeping cycle T. Specifically, in each frequency-sweeping cycle T, the start time of the first laser beam and the start time of the second laser beam may differ by half a cycle, the first laser beam may scan from zero frequency, and the second laser beam may scan from the maximum frequency f_{B}; or in the first half cycle and the second half cycle of each frequency-sweeping cycle T, the first laser beam increases linearly from zero frequency to the maximum frequency f_{B}, and the second laser beam decreases linearly from the maximum frequency f_{B} to zero frequency; or the second laser beam increases linearly from zero frequency to the maximum frequency f_{B}, and the first laser beam decreases linearly from the maximum frequency f_{B} to zero frequency.

In some embodiments, the LiDAR system further includes a wavelength division multiplexer 1303, configured to multiplex the first laser beam and the second laser beam into a frequency-sweeping beam. The frequency-sweeping beam carries two optical signals with different wavelengths λ₁ and λ₂; a first beam splitter 1304, configured to split the frequency-sweeping beam into a signal beam and a local oscillation light beam, wherein the signal beam and the local oscillation light beam have the same frequency at any time instant, that is, the frequency-modulation waveforms of the signal beam and the local oscillation light beam are exactly the same, and each of the signal beam and the local oscillation light beam simultaneously carries two optical signals with different wavelengths λ₁ and λ₂; an optical transceiver 1305, configured to transmit the signal beam and receive a reflected light beam generated by the reflection of the signal beam after encountering a target object.

Optionally, the LiDAR system 1300 also includes: a polarization beam splitter (e.g., a polarization splitter-rotator (PSR)) arranged between the optical transceiver 1305 and the target object 1306, configured to change the polarization direction of the light beam or merge multiple light beams into a polarized light beam; a lens assembly, configured to collimate the signal beam and focus the reflected light beam to couple it into the optical transceiver; and a beam-scanning guide device, configured to achieve light deflection and scanning.

In some embodiments, the LiDAR system also includes: an in-phase orthogonal coherent demodulator 1307, configured to perform in-phase orthogonal coherent demodulation on the local oscillation light beam and the reflected light beam so as to obtain scalar values of the beat frequency in the frequency-increasing stage and the beat frequency in the frequency-decreasing stage between the local oscillation light beam and the reflected light beam; and a first balanced detector 1308 and a second balanced detector 1309, configured to detect the beat frequency in the frequency-increasing stage and the beat frequency in the frequency-decreasing stage between the local oscillation light beam and the reflected light beam so as to determine the speed of the target object and/or the distance between the target object and the LiDAR system.

The scalar value of the beat frequency in the frequency-increasing stage includes a positive value or a negative value of the beat frequency in the frequency-increasing stage; the scalar value of the beat frequency in the frequency-decreasing stage includes a positive value or a negative value of the beat frequency in the frequency-decreasing stage.

Specifically, the in-phase orthogonal coherent demodulator 1307 may be a 90-degree frequency-mixing unit, specifically comprising: a second beam splitter 13071, a third beam splitter 13072, a first 2×2 coupler 13073, and a second 2×2 coupler 13074. The second beam splitter 13071 is configured to receive a local oscillation light beam from the first beam splitter 13042. The local oscillation light beam is split into two beams, which are respectively input to the first 2×2 coupler 13073 and the second 2×2 coupler 13074. The third beam splitter 13072 is configured to receive a reflected light beam from the optical transceiver 1305. The reflected light beam is split into two beams, which are respectively input to the first 2×2 coupler 13073 and the second 2×2 coupler 13074. The first 2×2 coupler 13073 is configured to couple the two light beams from the second beam splitter 13071 and the third beam splitter 13072 into two light beams with phases of 0° and 180°, respectively, and input the two light beams through the first output port and the second output port to the first balanced detector 1308. The second 2×2 coupler 13074 is configured to couple the two light beams from the second beam splitter 13071 and the third beam splitter 13072 into two light beams with phases of 90° and 270°, respectively, and input the two light beams through the third output port and the fourth output port to the second balanced detector 1309.

The first balanced detector 1308 includes a photodetector 1 and a photodetector 2, which are connected in series. The photodetector 1 is configured to receive the light with the phase of 0°, and the photodetector 2 is configured to receive the light with the phase of 180°. The second balanced detector 1309 includes a photodetector 3 and a photodetector 4. The photodetector 3 and the photodetector 4 are connected in series. The photodetector 3 is configured to receive the light with the phase of 90°, and the photodetector 4 is configured to receive the light with the phase of 270°. The DC components of the photocurrents obtained by the light beams at 0° and 180° and at 90° and 270° passing through the balanced detectors are equal.

The LiDAR device shown in FIG. 13 of the present application can obtain the scalar values of the beat frequency of the frequency-increasing stage and the frequency-decreasing stage of the local oscillation signal and the reflected signal, can expand the measurement spectrum range of the LiDAR system, avoid the measurement blind area caused by Doppler frequency shift, and improve the measurement accuracy. In addition, the device uses a dual-wavelength combined laser beam as the detection light signal, can simultaneously obtain the beat frequency of the frequency-increasing stage and the beat frequency of the frequency-decreasing stage at a sampling moment, can accurately obtain the speed and the distance of the target object, improve the angle-scanning accuracy of the LiDAR system, solve the problem of Doppler broadening causing the inability to distinguish the beat frequency of the frequency-increasing stage and the beat frequency of the frequency-decreasing stage in case of a too-close distance or a too-fast speed, can obtain the direction of the target speed, improve the signal-to-noise ratio of the signal, and solve the problem of dragging of the point cloud. The LiDAR device can implement the method steps described above. For the relevant content of the LiDAR system 1300, please refer to the relevant description of FIG. 5 above. This article will not repeat the description thereof here.

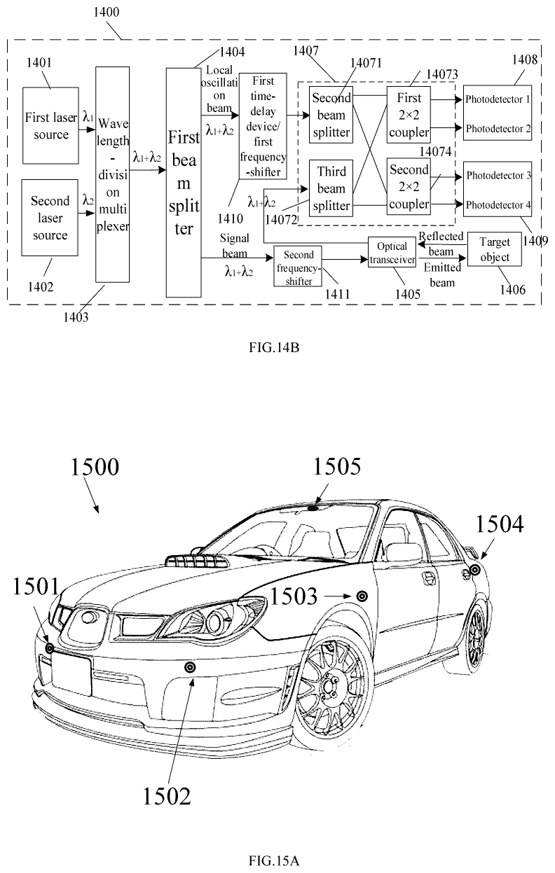

Referring to FIG. 14A and FIG. 14B, FIG. 14A is a second schematic diagram of the detailed structure of the LiDAR system of the present application, and FIG. 14B is a third schematic diagram of the detailed structure of the LiDAR system of the present application. In this embodiment, the LiDAR system 1400 includes a first laser source 1401 configured to generate a first laser beam; a second laser source 1402 configured to generate a second laser beam; and a wavelength division multiplexer 1403 configured to multiplex the first laser beam and the second laser beam into a frequency-sweeping beam. The frequency-sweeping beam carries two optical signals with different wavelengths λ₁ and λ₂; the first beam splitter 1404 is configured to split the frequency-sweeping beam into a signal beam and a local oscillation light beam, wherein the signal beam and the local oscillation light beam have the same frequency at any time instant, that is, the frequency-modulation waveforms of the signal beam and the local oscillation light beam are exactly the same, and each of the signal beam and the local oscillation light beam simultaneously carries two optical signals with different wavelengths λ₁ and λ₂; the optical transceiver 1405 is configured to transmit the signal beam and receive a reflected light beam generated by the reflection of the signal beam after encountering the target object; the in-phase orthogonal coherent demodulator 1407 is configured to perform in-phase orthogonal coherent demodulation on the local oscillation light beam and the reflected light beam to obtain the scalar values of the beat frequency in the frequency-increasing stage and the beat frequency in the frequency-decreasing stage between the local oscillation light beam and the reflected light beam; and the first balanced detector 1408 and the second balanced detector 1409 are configured to detect the beat frequency in the frequency-increasing stage and the beat frequency in the frequency-decreasing stage between the local oscillation light beam and the reflected light beam to determine the speed of the object and/or the distance between the target object and the LiDAR system.

The functions, principles and structures of the first laser source 1401, the second laser source 1402, the wavelength division multiplexer 1403, the first beam splitter 1404, the optical transceiver 1405, the in-phase orthogonal coherent demodulation 1407, the first balanced detector 1408 and the second detector 1409 are the same as the functions, principles and structures of the first laser source 1301, the second laser source 1302, the wavelength division multiplexer 1303, the first beam splitter 1304, the optical transceiver 1305, the in-phase orthogonal coherent demodulation 1307, the first balanced detector 1308 and the second detector 1309 described above. For details, please refer to the above description, and this application will not repeat the description thereof here.

Furthermore, the LiDAR system 1400 also includes a first time-delay device or a first frequency shifter 1410 and a second time-delay device or a second frequency shifter 1411.

In some embodiments, as shown in FIG. 14A, a first time-delay device or a first frequency shifter 1410 is disposed between the first beam splitter 1404 and the second beam splitter 14071, and the first time-delay device 1410 is configured to perform time-delay on the local oscillation light beam, and the first frequency shifter 1410 is configured to perform frequency-shift on the local oscillation light beam; a second time-delay device or a second frequency shifter 1411 is disposed between the first beam splitter 1404 and the third beam splitter 14072, and the second time-delay device 1411 is configured to perform time delay on the signal beam and the reflected light beam, and the second frequency shifter 1411 is configured to perform frequency shift on the signal beam and the reflected light beam.

In some embodiments, as shown in FIG. 14B, a first time-delay device or a first frequency shifter 1410 is disposed between the first beam splitter 1404 and the second beam splitter 14071, the first time-delay device 1410 is configured to perform time delay on the local oscillation light beam, and the first frequency shifter 1410 is configured to perform frequency shift on the local oscillation light beam; the second time-delay device 1411 is disposed between the first beam splitter 1404 and the optical transceiver 1405, and the second frequency shifter 1411 is configured to perform frequency shift on the signal beam.

By using the time delay and/or the frequency shift, the beat frequency of the frequency-increasing stage and the beat frequency of the frequency-decreasing stage between the local oscillation light beam and the reflected light beam can be moved to the positive direction or negative direction of the measurement spectrum, thereby expanding the range of the ranging spectrum, avoiding the measurement blind area caused by the beat frequency of the frequency-increasing stage and the beat frequency of the frequency-decreasing stage between the local oscillation light beam and the reflected light beam being outside the ranging-spectrum range of the LiDAR system, and improving the measurement accuracy. The principle of moving the beat frequency of the frequency-increasing stage and the beat frequency of the frequency-decreasing stage by time delay and/or frequency shift is described in the relevant description above in this application. In order to avoid repetition, this application is not described in detail here.

Optionally, the LiDAR system 1400 also includes: a polarization beam splitter (e.g., a polarization splitter-rotator (PSR)) arranged between the optical transceiver 1305 and the target object 1306, configured to change the polarization direction of the light beam or merge multiple light beams into a polarized light beam; a lens assembly, configured to collimate the signal beam and focus the reflected light beam to couple it into the optical transceiver; and a beam-scanning guide device, configured to achieve light deflection and scanning.

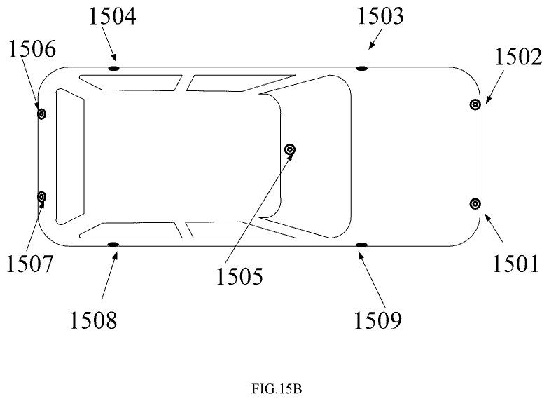

FIG. 15A and FIG. 15B illustrate an example autonomous vehicle 1500 according to an embodiment of the present application, which may include any of the components of the LIDAR device shown in FIGS. 13-14 of the present application. The autonomous vehicle 1500 shown includes a sensor array configured to capture one or more objects of the external environment of the autonomous vehicle and generate sensor data related to the captured one or more objects for controlling the operation of the autonomous vehicle 1500. FIG. 15A shows sensors 1501, 1502, 1503, 1504, and 1505. FIG. 15B illustrates sensors 1501, 1502, 1503, 1504, 1505, 1506, 1507, 1508, and 1509. FIG. 15B shows a top view of the autonomous vehicle 1500. Any one of sensors 1501, 1502, 1503, 1504, 1505, 1506, 1507, 1508 and 1509 may include the LiDAR system device shown in FIGS. 13-14 of the present application, which includes any component of the LIDAR device of the present application. The autonomous vehicle may include a powertrain, which includes a prime mover powered by an energy source and capable of providing power to the transmission system. The autonomous vehicle may also include a control system, which includes direction control, powertrain control and braking control. The autonomous vehicle can be implemented as any number of different vehicles, including vehicles that can transport people and/or goods and can travel in a variety of different environments. It should be understood that the above-mentioned components can be widely varied based on the type of vehicle utilizing these components.

The details of this embodiment of the present application can refer to the description of the aforementioned method embodiment. To avoid repetition, the present application will not repeat the description here.

Those of ordinary skill in the art will appreciate that the units and algorithm steps of each example described in conjunction with the embodiments disclosed herein can be implemented in electronic hardware, or a combination of computer software and electronic hardware. Whether these functions are performed in hardware or software depends on the specific application and design constraints of the technical solution. Professional and technical personnel can use different methods to implement the described functions for each specific application, but such implementation should not be considered to be beyond the scope of this application.

Those skilled in the art can clearly understand that, for the convenience and brevity of description, the specific working processes of the systems, devices and units described above can refer to the corresponding processes in the aforementioned method embodiments and will not be repeated here.

In the several embodiments provided in the present application, it should be understood that the disclosed systems, devices and methods can be implemented in other ways. For example, the device embodiments described above are only schematic. For example, the division of the units is only a logical function division. There may be other division methods in actual implementation, such as multiple units or components can be combined or integrated into another system, or some features can be ignored or not executed. Another point is that the mutual coupling or direct coupling or communication connection shown or discussed can be through some interfaces, indirect coupling or communication connection of devices or units, which can be electrical, mechanical or other forms.

The units described as separate components may or may not be physically separated, and the components shown as units may or may not be physical units, that is, they may be located in one place or distributed on multiple network units. Some or all of the units may be selected according to actual needs to achieve the purpose of the embodiment of the present application.

In addition, each functional unit in each embodiment of the present application may be integrated into one processing unit, or each unit may exist physically separately, or two or more units may be integrated into one unit.

If the functions are implemented in the form of software functional units and sold or used as independent products, they can be stored in a computer-readable storage medium. Based on this understanding, the technical solution of the present application can be essentially or partly embodied in the form of a software product that contributes to the related art. The computer software product is stored in a storage medium and includes several instructions for a computer device (which can be a personal computer, server, or network device, etc.) to perform all or part of the steps of the methods described in each embodiment of the present application. The aforementioned storage medium includes: various media that can store program codes, such as USB flash drives, mobile hard disks, read-only memories (ROM), random access memories (RAM), magnetic disks or optical disks.

The computer-readable storage media mentioned in this application may be volatile or non-volatile.

The above is only a specific implementation of the present application, but the protection scope of the present application is not limited thereto. Any technician familiar with the technical field can easily think of changes or substitutions within the technical scope disclosed in the present application, which should be included in the protection scope of the present application. Therefore, the protection scope of the present application should be based on the protection scope of the claims.

What is claimed is:

1. A laser measurement method applied to a Light Detection and Ranging (LiDAR) system, wherein the method comprises:
generating a first laser beam and a second laser beam, wherein the first laser beam and the second laser beam are frequency-modulated laser beams having a same frequency-sweeping cycle and different wavelengths, and frequencies of the first laser beam and the second laser beam change in opposite directions within each frequency-sweeping cycle;
multiplexing the first laser beam and the second laser beam into a frequency-sweeping beam;
splitting the frequency-sweeping beam into a signal beam and a local oscillation light beam;
emitting the signal beam;
receiving a reflected light beam generated when the signal beam is reflected by an object;
performing in-phase orthogonal coherent demodulation on the local oscillation light beam and the reflected light beam to obtain a scalar value of a beat frequency in a frequency-increasing stage and a scalar value of a beat frequency in a frequency-decreasing stage between the local oscillation light beam and the reflected light beam; and
detecting a phase and the beat frequency of the frequency-increasing stage between the local oscillation light beam and the reflected light beam, and a phase and the beat frequency of the frequency-decreasing stage between the local oscillation light beam and the reflected light beam, to determine a speed of the object and/or a distance between the object and the LiDAR system.

2. The laser measurement method according to claim 1, wherein the scalar value of the beat frequency in the frequency-increasing stage comprises a positive value or a negative value of the beat frequency in the frequency-increasing stage;
the scalar value of the beat frequency in the frequency-decreasing stage comprises a positive value or a negative value of the beat frequency in the frequency-decreasing stage.

3. The laser measurement method according to claim 1, wherein, before performing in-phase orthogonal coherent demodulation on the local oscillation light beam and the reflected light beam, the method further comprises:
performing time-delay or frequency-shift on at least one of the signal beam, the reflected light beam or the local oscillation light beam.

4. The laser measurement method according to claim 3, wherein performing time-delay on at least one of the signal beam, the reflected light beam or the local oscillation light beam comprises:
performing time-delay on the signal beam and the reflected light beam, or performing time-delay on the local oscillation light beam, so that the scalar value of the beat frequency in the frequency-increasing stage and the beat frequency in the frequency-decreasing stage between the local oscillation light beam and the reflected light beam increases or decreases.

5. The laser measurement method according to claim 3, wherein performing frequency-shift on at least one of the signal beam, the reflected light beam or the local oscillation light beam comprises:
performing frequency-shift on a frequency of the signal beam or the local oscillation light beam, so that the scalar values of the beat frequency in the frequency-increasing stage and the beat frequency in the frequency-decreasing stage between the local oscillation light beam and the reflected light beam increases or decreases.

6. The laser measurement method according to claim 1, wherein performing in-phase orthogonal coherent demodulation on the local oscillation light beam and the reflected light beam comprises:
inputting the reflected light beam and the local oscillation light beam into a 90-degree frequency-mixer to perform the in-phase orthogonal coherent demodulation.

7. The laser measurement method according to claim 4, wherein the beat frequency of the frequency-increasing stage and the beat frequency of the frequency-decreasing stage are located on both sides of a zero point position, when there is no Doppler frequency shift on a ranging spectrum of the LiDAR system, of the ranging spectrum.

8. The laser measurement method according to claim 1, wherein that the frequencies of the first laser beam and the second laser beam change in opposite directions within the frequency-sweeping cycle comprises one of following two situations:
in a first half cycle of the frequency-sweeping cycle, the first laser beam sweeps from zero frequency, and the second laser beam sweeps from a maximum frequency; in a second half cycle of the frequency-sweeping cycle, the first laser beam sweeps from the maximum frequency, and the second laser beam sweeps from zero frequency; or
in each of a first half cycle and a second half cycle of the frequency-sweeping cycle, the first laser beam sweeps from zero frequency, and the second laser beam sweeps from a maximum frequency.

9. A Light Detection and Ranging (LiDAR) system, comprising:
a first laser source configured to generate a first laser beam;
a second laser source configured to generate a second laser beam, wherein the first laser beam and the second laser beam are frequency-modulated laser having a same frequency-sweeping cycle and different wavelengths, and frequencies of the first laser beam and the second laser beam change in opposite directions within the frequency-sweeping cycle;
a wavelength division multiplexer configured to multiplex the first laser beam and the second laser beam into a frequency-sweeping beam;
a beam splitter configured to split the frequency-sweeping beam into a signal beam and a local oscillation light beam;
an optical transceiver configured to transmit the signal beam and receive a reflected light beam generated when the signal beam is reflected by an object;
an in-phase orthogonal coherent demodulator configured to perform in-phase orthogonal coherent demodulation on the local oscillation light beam and the reflected light beam, so as to obtain a scalar value of a beat frequency in a frequency-increasing stage and a scalar value of a beat frequency in a frequency-decreasing stage between the local oscillation light beam and the reflected light beam; and
a detector configured to detect the beat frequency of the frequency-increasing stage and the beat frequency of the frequency-decreasing stage between the local oscillation light beam and the reflected light beam to determine a speed of the object and/or the distance between the object and the LiDAR system.

10. The LiDAR system according to claim 9, wherein the scalar value of the beat frequency in the frequency-increasing stage comprises a positive value or a negative value of the beat frequency in the frequency-increasing stage;
the scalar value of the beat frequency in the frequency-decreasing stage includes a positive value or a negative value of the beat frequency in the frequency-decreasing stage.

11. The LiDAR system according to claim 9, wherein the LiDAR system further comprises:
a time-delay device configured to perform time-delay on at least one of the signal beam, the reflected light beam and the local oscillation light beam before performing in-phase orthogonal coherent demodulation on the local oscillation light beam and the reflected light beam; and/or
a frequency shifter configured to perform frequency-shift on at least one of the signal beam, the reflected light beam and the local oscillation light beam before performing in-phase orthogonal coherent demodulation on the local oscillation light beam and the reflected light beam.

12. The LiDAR system according to claim 11, wherein the time-delay device is specifically configured to perform time-delay on the signal beam and the reflected light beam, or perform time-delay on the local oscillation light beam, so that the scalar value of the beat frequency in the frequency-increasing stage and the scalar value of the beat frequency in the frequency-decreasing stage between the local oscillation light beam and the reflected light beam increase or decrease;
the frequency shifter is specifically configured to perform frequency-shift on the signal beam or the local oscillation light beam so that the scalar value of the beat frequency in the frequency-increasing stage and the scalar value of the beat frequency in the frequency-decreasing stage between the local oscillation light beam and the reflected light beam increase or decrease.

13. The LiDAR system according to claim 9, wherein the in-phase orthogonal coherent demodulator is specifically configured to receive the reflected light beam and the local oscillation light beam to obtain the scalar value of the beat frequency in the frequency-increasing stage and the scalar value of the beat frequency in the frequency-decreasing stage between the local oscillation light beam and the reflected light beam.

14. The LiDAR system according to claim 12, wherein the beat frequency of the frequency-increasing stage and the beat frequency of the frequency-decreasing stage are located on both sides of a zero point position, when there is no Doppler frequency shift on a ranging spectrum of the LiDAR system, of the ranging spectrum.

15. The LiDAR system according to claim 9, wherein that the frequencies of the first laser beam and the second laser beam change in opposite directions within the frequency-sweeping cycle comprises one of following two situations:
in a first half cycle of the frequency-sweeping cycle, the first laser beam sweeps from zero frequency, and the second laser beam sweeps from a maximum frequency; in a second half cycle of the frequency-sweeping cycle, the first laser beam sweeps from the maximum frequency, and the second laser beam sweeps from zero frequency; or
in each of a first half cycle and a second half cycle of the frequency-sweeping cycle, the first laser beam sweeps from a zero frequency, and the second laser beam sweeps from a maximum frequency.

16. An autonomous vehicle, comprising:
the LiDAR system according to claim 9.
